(19) United States
(12) Patent Application Publication
(10) Pub. No.: US 2026/0221467 A1
(43) Pub. Date: Jul. 30, 2026

(54) BINDER FOR MEMBRANE-ELECTRODE ASSEMBLY CONTAINING POROUS MATERIAL AND METHOD OF PREPARING SAME

(71) Applicants: Hyundai Motor Company, Seoul (KR); Kia Corporation, Seoul (KR)

(72) Inventors: Sang Jin Han, Hwaseong (KR); Il Seok Chae, Hwaseong (KR); Seong Hun Cho, Hwaseong (KR)

(21) Appl. No.: 19/292,502

(22) Filed: Aug. 6, 2025

(30) Foreign Application Priority Data
Jan. 24, 2025 (KR) 10-2025-0011048

(51) Int. Cl. H01M 4/86; H01M 4/88

(52) U.S. Cl. CPC H01M 4/8668; H01M 4/8626; H01M 4/88

(57) ABSTRACT

Provided is a binder for membrane-electrode assemblies. It includes a polymer with multiple hydrogen ion-conducting functional groups and a porous material associated with at least one of those groups. The polymer may feature side chains containing carboxyl, phosphoric acid, or sulfonic acid groups, and can be based on perfluorosulfonic acid or hydrocarbon polymers. The porous material may have hydroxyl groups and can include substances such as cyclodextrin, calixarene, pillararene, or cage polymers. A method of preparing the binder involves mixing the polymer and porous material, then heat treating to promote their interaction. This binder can enhance oxygen permeability and improve the performance of membrane-electrode assemblies.

### CROSS REFERENCE TO RELATED APPLICATION

The present application claims under 35 U.S.C. § 119 (a) the benefit of Korean Patent Application No. 10-2025-0011048, filed Jan. 24, 2025, the entire contents of which is incorporated herein for all purposes by this reference.

### BACKGROUND

### Technical Field

The present disclosure relates to a binder for a membrane-electrode assembly, which has excellent gas permeability by containing a porous material, and a method of preparing the same.

### Background

Electrodes of a proton exchange membrane fuel cell (PEMFC) contain a binder and a catalyst, such as a platinum-supported catalyst. The catalyst such as a platinum-supported catalyst is expensive, so it is desirable to reduce its usage. However, the amount of catalysts used has a decisive impact on the performance of fuel cells, and thus the amount is a key variable.

In general, reducing the amount of catalyst used leads to decreased battery performance. This is because a relative increase in the content of a binder such as Nafion causes pore blocking by the binder, which lowers oxygen diffusion. Additionally, as the content of a binder increases relatively, thickness of a binder layer surrounding a platinum-supported catalyst in an electrode layer increases. As a result, resistance such as gas diffusion and proton conduction increases, which may reduce performance.

Previous attempts to improve oxygen diffusion involved introducing polymer electrolytes with large free volume into the electrode.

Recently, to improve gas permeation and mass transfer, a mixed matrix membranes (MMMs) strategy has been attempted by adding porous nanomaterials such as zeolites and metal organic frameworks (MOFs) to polymer substrates. This strategy involves embedding porous materials into a substrate with a relatively low free volume, and herein, the relatively low free volume results from thermal movement of polymer segments. The strategy increases free volume and gas permeability by reducing mass transfer resistance.

However, these techniques and strategy have many limitations in their application due to dispersion problems of porous nanomaterials and compatibility with a polymer substrate.

### SUMMARY

The present disclosure provides a binder for a membrane-electrode assembly, where the binder contains a porous material capable of being highly dispersed and increasing free volume of the binder, and also to provide a method of preparing the same binder.

The present disclosure also provides a binder for a membrane-electrode assembly, where the binder contains the porous material with a low elution possibility during operation of the membrane-electrode assembly, and a method of preparing the same binder.

The present disclosure also provides an electrode of a membrane-electrode assembly containing the binder.

The purposes of the present disclosure are not limited to the purposes mentioned above. The purposes of the present disclosure will become clearer from the following description and may be realized by means and combinations thereof as set forth in the claims.

A binder for a membrane-electrode assembly according to an embodiment of the present disclosure may include: a polymer material containing a plurality of hydrogen ion conducting functional groups; and a porous material associated with at least one of the hydrogen ion conducting functional groups.

The hydrogen ion conducting functional groups may contain one or more of a carboxyl group (—COOH), a phosphoric acid group (—PO₃H) and a sulfonic acid group (—SO₃H).

The polymer material may contain a main chain; and a side chain attached to the main chain, where the side chain may contain the hydrogen ion conducting functional group.

The polymer material may contain one or more of a perfluorosulfonic acid-based polymer and a hydrocarbon-based polymer.

The polymer material may have an equivalent weight of about 300 g/mol to 1,100 g/mol.

The porous material may contain a hydroxyl group, and the hydroxyl group may be associated with the hydrogen ion conducting functional group.

The porous material may contain one or more of cyclodextrin, calixarene, pillararene and cage polymer.

A pore size of the porous material may be larger than a kinetic diameter of an oxygen molecule.

The binder may have an oxygen permeability of about 0.21 barrer or more.

The binder may contain about 5 to 20 parts by weight of the porous material based on 100 parts by weight of the polymer material.

An electrode for a membrane-electrode assembly according to another embodiment of the present disclosure may include: the binder; and a catalyst.

A method of preparing a binder for a membrane-electrode assembly according to a further embodiment of the present disclosure may include: preparing a mixture of a porous material and a polymer material containing a plurality of hydrogen ion conducting functional groups; and heat treating the mixture. Through the heat treatment, the porous material may be associated with at least one of the hydrogen ion conducting functional groups.

The heat treatment may be performed in a vacuum atmosphere at about 120° C. to 160° C. for about 10 minutes to 2 hours.

According to the present disclosure, a binder for a membrane-electrode assembly, where the binder contains a porous material capable of being highly dispersed and increasing free volume of the binder, and a method of preparing the same binder can be obtained.

According to the present disclosure, a binder for a membrane-electrode assembly, where the binder contains a porous material with low elution possibility during operation of the membrane-electrode assembly, and a method of preparing the same binder can be obtained.

According to the present disclosure, a binder for a membrane-electrode assembly, where the binder is capable of reducing the amount of catalyst used, such as a platinum-supported catalyst, and a method of preparing the same binder can be obtained.

According to the present disclosure, an electrode of a membrane-electrode assembly containing the binder can be obtained.

Effects of the present disclosure are not limited to the effects mentioned above. The effects of the present disclosure should be understood to include all effects that can be inferred from the following description.

### BRIEF DESCRIPTION OF THE DRAWINGS

FIG. 1 shows a membrane-electrode assembly according to some embodiments of the present disclosure; and

FIG. 2 shows results of verifying an electrode IV performance of the membrane-electrode assembly according to Example 1, Example 2, Comparative Example 1, and Comparative Example 2.

### DETAILED DESCRIPTION OF VARIOUS EMBODIMENTS

The purposes, other purposes, features, and advantages of the present disclosure will be easily understood through the following various embodiments related to the attached drawings. However, the present disclosure is not limited to the embodiments described herein and may be embodied in other forms. Rather, the embodiments introduced herein are provided so that the disclosed content will be thorough and complete and so that the technical characteristics of the present disclosure can be sufficiently conveyed to those skilled in the art.

With describing each drawing, similar reference numerals are used for similar components. In the attached drawings, the dimensions of the structures are enlarged from the actual size for clarity of the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In this specification, terms such as “comprise” or “have” are intended to indicate the presence of features, numbers, steps, operations, components, parts, or combinations thereof described in the specification. The terms should be understood as not precluding the presence or addition of one or more other features, numbers, steps, operations, components, parts, or combinations thereof. Additionally, under a condition that a part of a layer, membrane, region, and plate is said to be “on” another part, this includes not only being “directly above” the other part but also cases where there is another part in between. Conversely, under a condition that a part of a layer, membrane, region, and plate is said to be “underneath” another part, this includes not only being “directly below” the other part, but also cases where there is another part in between.

The term “hydrogen ion conducting functional group” as used herein refers to an acidic moiety capable of donating and/or exchanging protons.

The term “porous material” a used herein refers to a substance containing pores or voids that can facilitate mass transport.

The term “perfluorosulfonic acid-based polymer” as used herein refers to a fluorinated polymer functionalized with sulfonic acid groups.

The term “hydrocarbon-based polymer” as sed herein refer to polymers composed primarily of carbo and hydrogen backbones, which may include hydrogen ion conducting functional groups.

Unless otherwise indicated, all numbers, values, and/or expressions used herein expressing quantities of components, reaction conditions, polymer compositions and formulations are to be understood in all cases as being qualified by the term “about” since such numbers are inherently approximations that consider, among other things, the various uncertainties of measurement that arise in obtaining such values. Additionally, where a numerical range is disclosed herein, such range is continuous and, unless otherwise indicated, includes all values from the lower to the upper limits of such a range. Furthermore, under a condition that such a range refers to an integer, all integers from the lower limit up to and including the upper limit are included, unless otherwise indicated.

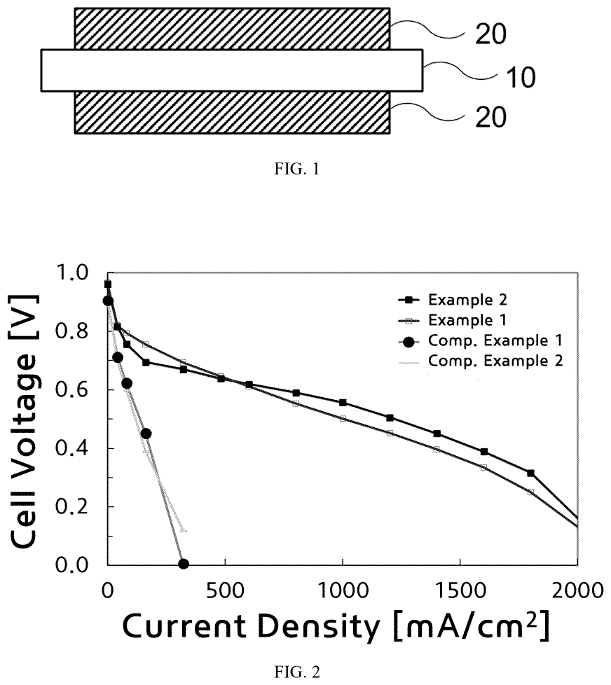

FIG. 1 shows a membrane-electrode assembly according to the present disclosure. The membrane-electrode assembly may include an electrolyte membrane 10 and a pair of electrodes 20 located on both sides of the electrolyte membrane 10. The pair of electrodes 20 may have polarities opposite to each other. In case an electrode is a cathode, the other electrode may be an anode.

Each pair of electrodes 20 may include a catalyst and a binder.

The catalyst may contain an active metal such as platinum (Pt). The active metal may be supported on a carrier such as a carbon material.

The binder may include: a polymer material containing a plurality of hydrogen ion conducting functional groups; and a porous material bonded to at least one hydrogen ion conducting functional group.

In the present disclosure, the porous material is introduced into the binder to increase gas permeability of each of the pair of electrodes, but rather than simply mixing the polymer material and the porous material, the porous material is bonded to the polymer material through a covalent bond or the like, leading to increases in the dispersibility and miscibility of the porous material. The gas permeability may mean permeability of hydrogen gas and/or the permeability of oxygen gas and may mean the permeability of oxygen gas. The molecule of hydrogen gas is small, so the molecule of hydrogen gas is not difficult to move within each of the pair of electrodes 20. Meanwhile, a molecule of oxygen gas is large. Due to that, applying a binder containing porous material to each of the pair of electrodes 20 can increase the permeability of oxygen gas.

The polymer material may contain a main chain, and a side chain connected to the main chain. The side chain may contain a hydrogen ion conducting functional group. The hydrogen ion conducting functional group may be located at an end of the side chain.

The hydrogen ion conducting functional group may contain one or more of a carboxyl group (—COOH), a phosphoric acid group (—PO₃H) and a sulfonic acid group (—SO₃H).

The polymer material may contain one or more of a perfluorosulfonic acid-based polymer and a hydrocarbon-based polymer.

The perfluorosulfonic acid-based polymer has the advantages of high proton conductivity, excellent mechanical properties, chemical resistance, durability, and handling properties, as well as the perfluorosulfonic acid-based polymer has a well-established history of mass production. The perfluorosulfonic acid-based polymer may be broadly classified into Nafion™ with a long side chain and Aquivion™ with a short side chain depending on its side chain structure. In addition, the perfluorosulfonic acid-based polymer may contain a sulfonic acid group and a carboxyl group as a functional group in an end group of the side chain.

The hydrocarbon-based polymer may be based on a compound, which is easier to polymerize or copolymerize with various molecular structures compared to the perfluorosulfonic acid-based polymer. The hydrocarbon-based polymer may include one or more of sulfonated polyphenylene containing a sulfonic acid group, sulfonated polyethylene containing a sulfonic acid group, sulfonated polypropylene, sulfonated polystyrene, sulfonated polysulfone, sulfonated polybenzimidazole, sulfonated poly(phenylene oxide) or sulfonated poly(phenylene ether), sulfonated poly(arylene ether ketone), sulfonated poly(ether ether ketone), sulfonated poly(ether ketone), sulfonated polyimide, sulfonated poly(ether imide), and sulfonated poly(styrene-b-ethylene-r-butadiene-b-styrene) tri-block copolymer.

The polymer material may have an equivalent weight (EW) of 300 g/mol to 1,100 g/mol. The method for measuring the equivalent weight is not particularly limited, but the equivalent weight may be determined through a molecular weight of a monomer obtained by hydrolyzing the polymer materials, obtained by measuring a molecular weight of the polymer material, or determined by analyzing a structure of the polymer material through spectroscopy such as nuclear magnetic resonance. Under a condition that the equivalent weight of the polymer material is less than 300 g/mol, the content of hydrogen ion conducting functional group is high, and the moisture content of each of the pair of electrodes increases. As a result, phenomena such as swelling of an electrode may occur, which may reduce the dimensional stability of the electrode. Under the condition that the equivalent weight of the polymer material exceeds 1,100 g/mol, the content of the hydrogen ion conducting functional group may be small, and the hydrogen ion conductivity in each of the pair of electrodes may be reduced.

The porous material is used to increase gas permeability within each of the pair of electrodes and may be bonded to at least one hydrogen ion conducting functional group of the polymer material.

The hydrogen ion conducting functional group not bonded to the porous material may be responsible for the movement of hydrogen ions within each of the pair of electrodes. The bonding ratio of the porous materials is not particularly limited, but the bonding ratio of the porous material may be about 10% or more, 20% or more, or 30% or more, and about 90% or less, 80% or less, 70% or less, 60% or less, or 50% or less based on the total content of the hydrogen ion conducting functional group.

The porous material may include a macrocyclic host molecule, and in particular, may include a hydroxyl group to bind to the polymer material. The hydroxyl group may be bonded to at least one hydrogen ion conducting functional group of the polymer material.

The porous material may contain one or more of cyclodextrin, calixarene, pillararene and cage polymer.

The cyclodextrin may include a compound represented by Formula 1 below.

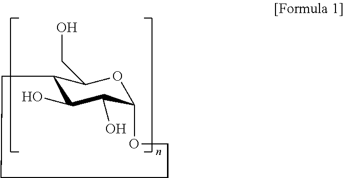

In Formula 1, n may be a number in a range of 6 to 8.

The cyclodextrin may contain one or more of α-cyclodextrin, β-cyclodextrin, γ-cyclodextrin and derivatives thereof.

The calixarene may include a compound represented by Formula 2 below.

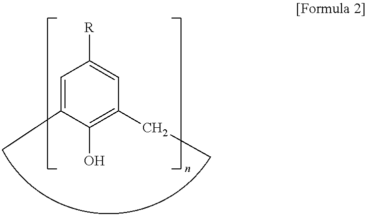

In Formula 2, R may include a substituted or unsubstituted alkyl group having 1 to 4 carbon atoms, and n may be 4, 6, or 8.

The pillararene may include a compound represented by Formula 3 below.

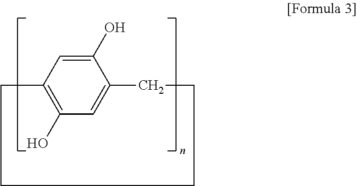

In Formula 3, n may be a number in the range of 5 to 10.

The cage polymer may include a compound represented by Formula 4 below.

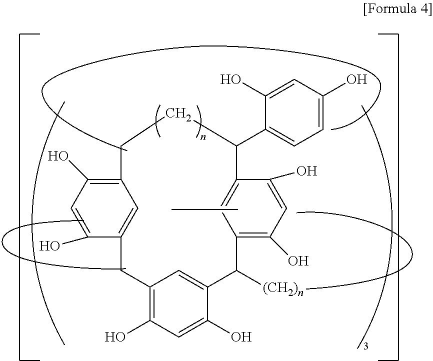

In Formula 4, n may be a number in a range of 3 to 5.

A reaction between the porous material and the polymer material may be illustratively performed as shown in a reaction formula below. In the reaction formula, the hydrogen ion conducting functional group of the polymer material is designated as a sulfonic acid group, and the porous material is designated as β-cyclodextrin. The hydrogen ion conducting functional group of the polymer material reacts with the hydroxyl group of the porous material and undergo esterification, leading to formation of a binder in which the polymer material and the porous material are covalently bonded.

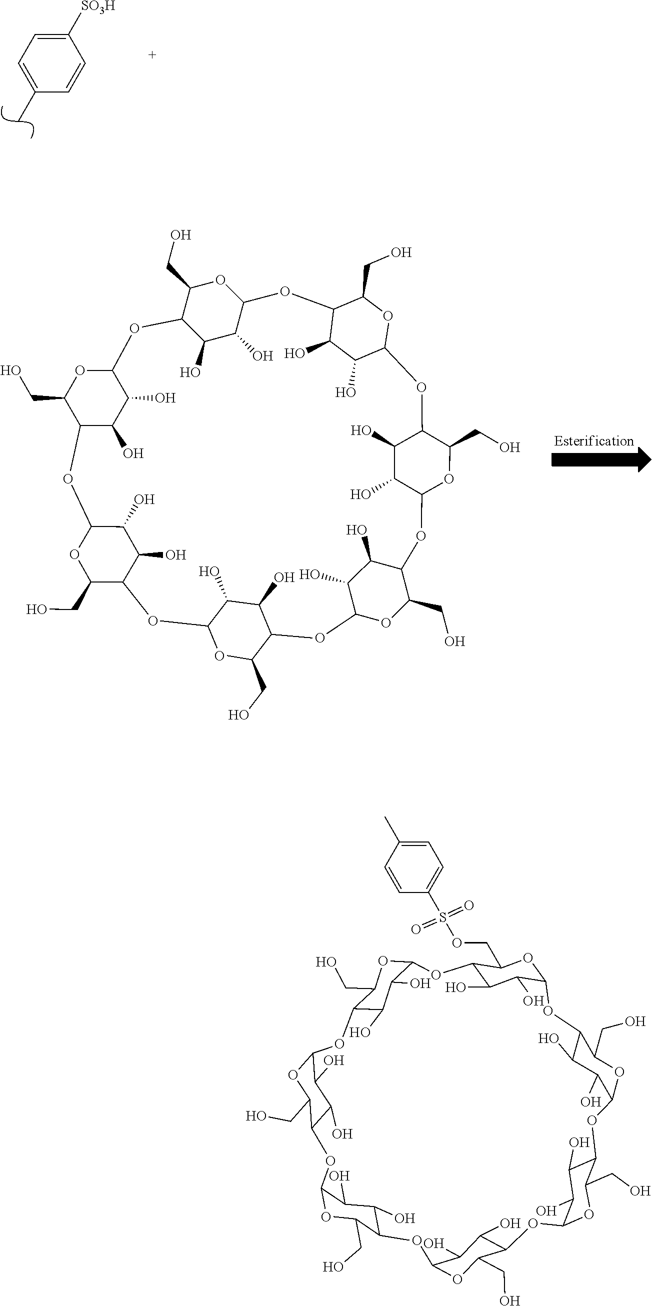 [SMILES: Cc1ccc(S(=O)(=O)O)cc1 ; OC[C@H]1OC2OC3[C@@H](CO)OC(OC4[C@@H](CO)OC(OC5[C@@H](CO)OC(OC6[C@@H](CO)OC(OC7[C@@H](CO)OC(OC8[C@@H](CO)OC(OC1[C@H](O)[C@H]2O)[C@H](O)[C@H]8O)[C@H](O)[C@H]7O)[C@H](O)[C@H]6O)[C@H](O)[C@H]5O)[C@H](O)[C@H]4O)[C@H](O)[C@H]3O ; Cc1ccc(S(=O)(=O)OCC2OC3OC4C(CO)OC(OC5C(CO)OC(OC6C(CO)OC(OC7C(CO)OC(OC8C(CO)OC(OC9C(CO)OC(OC2C(O)C3O)C(O)C9O)C(O)C8O)C(O)C7O)C(O)C6O)C(O)C5O)C(O)C4O)cc1]

A pore size of the porous material may be larger than a kinetic diameter of the oxygen molecule. The pore size may refer to a diameter of an empty space or a hole formed inside the porous material. The pore size may be measured through X-ray diffraction analysis, scanning electron microscopy analysis, gas adsorption analysis, or nuclear magnetic resonance analysis. The kinetic diameter is a concept representing the size of a molecule and may refer to the size of a gas molecule during collision or movement of the gas molecule. The kinetic diameter of the oxygen molecule may be about 0.346 nm. The pore size of the porous material is large compared to the kinetic diameter of the oxygen molecule. Due to that, the oxygen molecule can easily move through the porous material to a catalyst in each of the pair of electrodes.

The pore size of the cyclodextrin may be about 1.37 nm to 1.69 nm, which is larger than the kinetic diameter of the oxygen molecules. A pore size of the calixarene is 0.4 nm, 0.76 nm, and 1.17 nm, respectively, under a condition that n of the compound represented by Formula 2 is 4, 6, and 8. The pore size of the calixarene may be larger than the kinetic diameter of the oxygen molecules. A pore size of the pillararene is 0.47 nm and 0.67 nm, respectively, under a condition that n of the compound represented by Formula 3 is 5 and 10. The pore size of the pillararene may be larger than the kinetic diameter of the oxygen molecules.

The binder may include 5 to 20 parts by weight of the porous material based on 100 parts by weight of the polymer material. Under a condition that the content of the porous material exceeds 20 parts by weight, the content of the binder increases compared to the catalyst in each of the pair of electrodes. This may deteriorate the performance of the membrane-electrode assembly. Under a condition the content of the porous material is less than 5 parts by weight, the degree of improvement in gas permeability of each of the pair of electrodes may not be sufficient.

A method of preparing a binder for a membrane-electrode assembly according to the present disclosure may include: preparing a mixture of a polymer material containing a plurality of hydrogen ion conducting functional groups, and of a porous material; and heat treating the mixture. Through the heat treatment, the porous material may be bonded to at least one hydrogen ion conducting functional group.

The heat treatment may be performed in a vacuum atmosphere at 120° C. to 160° C. for 10 minutes to 2 hours. Under the condition that the temperature of the heat treatment is less than 120° C., a bonding reaction rate between the polymer material and the porous material may be slow. In case polymer material and porous material are bonded into a solid-solid phase by inducing a reaction within the electrolyte membrane matrix, a smooth molecular motion may not occur. Under a condition that the temperature of the heat treatment exceeds 160° C., the structure of the polymer material may be deformed. For example, the bonds between carbon and sulfur that make up the polymer material may be decomposed.

One of various embodiments of the method of preparing an electrode for a membrane-electrode assembly according to the present disclosure may include: obtaining a binder solution by dissolving a binder obtained by a binder preparation method in a solvent, obtaining a slurry by mixing the binder solution with a catalyst, and obtaining an electrode by applying and drying the slurry on a substrate. The solvent is not particularly limited, but may include an alcohol-based solvent, an aqueous solvent, or a mixture thereof.

An another of various embodiments of the method of preparing an electrode for a membrane-electrode assembly according to the present disclosure may include: obtaining a slurry by mixing a polymer material, a porous material, and a catalyst, obtaining a layer-shaped membrane by applying the slurry on a substrate, and obtaining an electrode by heat treating the membrane. The membrane may be heat treated to combine the polymer material and the porous material. The heat treatment may be performed in a vacuum atmosphere at 120° C. to 160° C. for 10 minutes to 2 hours.

Other forms of the present disclosure will be described in more detail through examples below. The following examples are merely examples to aid understanding of the present disclosure, and the scope of the present disclosure is not limited to the examples.

### Preparation Example 1

A first solution containing 5% by weight of polymer material and 95% by weight of solvent was prepared. The polymer material was sulfonated polyphenylene with an equivalent weight of about 350 g/mol. The solvent was a solvent mixture containing n-propyl alcohol and water in a mass ratio of 1:1.

A second solution containing a porous material and the same solvent as above was prepared. The first solution and the second solution were mixed so that the porous material became 5 parts by weight based on 100 parts by weight of the polymer material.

The resulting product was applied on a substrate and dried at about 80° C. As a result, a layer-shaped membrane was obtained.

The membrane was heat treated at about 150° C. for about 30 minutes in a vacuum atmosphere. As a result, a membrane containing a binder of esterified polymer material and porous material was prepared.

### Preparation Example 2

A membrane was prepared in the same manner as Preparation Example 1, except that the content of the porous material was changed to 10 parts by weight.

### Preparation Example 3

A membrane was prepared in the same manner as Preparation Example 1, except that the content of the porous material was changed to 20 parts by weight.

### Comparative Preparation Example 1

The first solution of Preparation Example 1 was applied on a substrate and dried at about 80° C. As a result, a layer-shaped membrane was obtained.

### Comparative Preparation Example 2

The resulting product of mixing the first and second solutions of Preparation Example 1 was applied on a substrate and dried at about 80° C. As a result, a layer-shaped membrane was obtained. That means heat treatment was not performed, unlike Preparation Example 1. This resulted in a membrane containing a binder of simply mixed polymer material and porous material being prepared.

The oxygen permeability of the membranes according to Preparation Examples 1 to 3, Comparative Preparation Example 1, and Comparative Preparation Example 2 was measured using time lag (ASTM Method D1434-82) equipment. Time Lag was a vacuum chamber equipment that enabled measurement of the permeability coefficient (Po) and diffusion coefficient (D) of gas, which penetrates a membrane in a steady state. Table 1 below shows the oxygen permeability of each sample membrane with a thickness of about 20 μm and an effective area of about 2.25 cm² under non-humidifying conditions at 25° C.

Comparative Preparation Example 1 and Comparative Preparation Example 2 had an oxygen permeability of about 0.16 barrer. In particular, referring to the results of Comparative Preparation Example 2, it was confirmed that even under the condition that a porous material was added, the oxygen permeability of the membrane could not be increased as the porous material was simply mixed with the polymer material. This was because the dispersibility of the porous material was low, and there was a high possibility that the porous material would be lost during the measurement process.

On the other hand, Preparation Examples 1 to 3 showed high oxygen permeability of about 0.21 barrer or more. The upper limit of the oxygen permeability was not particularly limited, but might be 2 barrer or less, or 1.5 barrer or less. As the amount of porous material added increased, oxygen permeability improved. Preparation Example 3, in which the content of porous material was 20 parts by weight, showed an improvement in oxygen permeability by about 5 times or more compared to Comparative Preparation Example 1 and Comparative Preparation Example 2. It was confirmed that the oxygen permeability of an electrode could be increased as the porous material was applied by covalently bonding to the polymer material. According to the present disclosure, the oxygen permeability of an electrode could be increased, so the amount of catalyst used could be reduced. This could greatly contribute to reducing the costs of the membrane-electrode assembly.

### Example 1

The membrane containing the binder obtained in Preparation Example 2 was dissolved in a solvent mixture of n-propyl alcohol and water in a mass ratio of 1:1 so that the content of the membrane was about 5% by weight. By mixing the resulting product with a catalyst, n-propyl alcohol, and water, a slurry with a solid content of 10% by weight was prepared. The catalyst is platinum supported on a carbon carrier. I/C (ionomer/carbon) in the slurry was 1.

The slurry was applied and dried on a substrate to prepare electrodes.

The electrodes were applied to both sides of the electrolyte membrane via transfer, resulting in a membrane-electrode assembly.

### Example 2

A membrane-electrode assembly was prepared in the same manner as in Example 1, except that a membrane containing the binder obtained in Preparation Example 3 was used.

### Comparative Example 1

A membrane-electrode assembly was prepared in the same manner as in Example 1, except that a membrane containing the binder obtained in Comparative Preparation Example 1 was used.

### Comparative Example 2

A membrane-electrode assembly was prepared in the same manner as in Example 1, except that a membrane containing the binder obtained in Comparative Preparation Example 3 was used.

FIG. 2 shows results of verifying an electrode IV performance of the membrane-electrode assembly according to Example 1, Example 2, Comparative Example 1, and Comparative Example 2. The electrode area was about 25 cm². The catalyst loading of a cathode was approximately 0.4 mgPt/cm². The catalyst loading of an anode was approximately 0.1 mgPt/cm². Hydrogen/air was 1.5/2.0 stoichiometric ratio (S.R). SGL's 10 BC was used as the gas diffusion layer. Performance was evaluated by applying a carbon separator.

Referring to FIG. 2, the membrane-electrode assembly according to Examples 1 and 2 showed excellent IV performance compared to Comparative Examples 1 and 2.

As described above, examples of the present disclosure have been described in detail. The scope of rights of the present disclosure is not limited to the above-described examples, and various modifications and improvements made by those skilled in the art using the basic concept of the present 5 disclosure defined in the following claims are also included in the scope of rights of the present disclosure.

What is claimed is:

1. A binder for a membrane-electrode assembly, the binder comprising:
a polymer material comprising a plurality of hydrogen ion conducting functional groups; and
a porous material associated with at least one of the hydrogen ion conducting functional groups.

2. The binder of claim 1, wherein the hydrogen ion conducting functional groups comprise one or more of a carboxyl group (—COOH), a phosphoric acid group (—PO₃H) and a sulfonic acid group (—SO₃H).

3. The binder of claim 1, wherein the polymer material comprises:
a main chain; and
a side chain attached to the main chain,
wherein the side chain comprises the hydrogen ion conducting functional group.

4. The binder of claim 1, wherein the polymer material comprises one or more of a perfluorosulfonic acid-based polymer and a hydrocarbon-based polymer.

5. The binder of claim 1, wherein the polymer material has an equivalent weight of about 300 g/mol to 1,100 g/mol.

6. The binder of claim 1, wherein the porous material comprises a hydroxyl group, wherein the hydroxyl group is associated with the hydrogen ion conducting functional groups.

7. The binder of claim 1, wherein the porous material comprises one or more of cyclodextrin, calixarene, pillararene and cage polymer.

8. The binder of claim 1, wherein a pore size of the porous material is larger than a kinetic diameter of an oxygen molecule.

9. The binder of claim 1, wherein the binder has an oxygen permeability of about 0.21 barrer or more.

10. The binder of claim 1, wherein the binder comprises about 5 to 20 parts by weight of the porous material based on 100 parts by weight of the polymer material.

11. An electrode for a membrane-electrode assembly, the electrode comprising:
the binder of claim 1; and
a catalyst.

12. A method of preparing a binder for a membrane-electrode assembly, the method comprising:
preparing a porous material and a mixture of a polymer material comprising a plurality of hydrogen ion conducting functional groups; and
heat treating the mixture, thereby associating the porous material with at least one of the hydrogen ion conducting functional groups.

13. The method of claim 12, wherein the hydrogen ion conducting functional groups comprise one or more of a carboxyl group (—COOH), a phosphoric acid group (—PO₃H) and a sulfonic acid group (—SO₃H).

14. The method of claim 12, wherein the polymer material comprises one or more of a perfluorosulfonic acid-based polymer and a hydrocarbon-based polymer.

15. The method of claim 12, wherein the polymer material has an equivalent weight of about 300 g/mol to 1,100 g/mol.

16. The method of claim 12, wherein the porous material comprises a hydroxyl group,
wherein the hydroxyl group is associated with the hydrogen ion conducting functional groups.

17. The method of claim 12, wherein the porous material comprises one or more of cyclodextrin, calixarene, pillararene and cage polymer.

18. The method of claim 12, wherein a pore size of the porous material is larger than a kinetic diameter of an oxygen molecule.

19. The method of claim 12, wherein the heat treatment is performed at about 120° C. to 160° C.

20. The method of claim 12, wherein the binder comprises about 5 to 20 parts by weight of the porous material based on 100 parts by weight of the polymer material.
